(19) United States
(12) Patent Application Publication
(10) Pub. No.: US 2021/0316441 A1
(43) Pub. Date: Oct. 14, 2021

(54) Connection tool

(71) Applicant: HUANG TING YA, Taichung City (TW)

(72) Inventor: HUANG TING YA, Taichung City (TW)

(21) Appl. No.: 17/110,322

(22) Filed: Dec. 3, 2020

(30) Foreign Application Priority Data
Apr. 9, 2020 (TW) 109204131

(51) Int. Cl. B25H 3/00

(52) U.S. Cl. CPC B25H 3/003

(57) ABSTRACT

A connection tool contains a first fixing portion and a second fixing portion. The first fixing portion includes a first large-diameter hexagonal hole, a first small-diameter hexagonal hole extending inward from the first large-diameter hexagonal hole, and a first engagement orifice defined on an outer wall of the first fixing portion proximate to the first large-diameter hexagonal hole and communicating with the first small-diameter hexagonal hole. The second fixing portion includes a second large-diameter hexagonal hole, a second small-diameter hexagonal hole extending inward from the second large-diameter hexagonal hole, and a second engagement orifice defined on an outer wall of the second fixing portion proximate to the second large-diameter hexagonal hole and communicating with the second small-diameter hexagonal hole, wherein a diameter of the first large-diameter hexagonal hole is less than a diameter of the second large-diameter hexagonal hole.

### FIELD OF THE INVENTION

The present invention relates to a connection tool which obtains multi-purpose use.

### BACKGROUND OF THE INVENTION

A conventional connection tool is configured to connect with a workpiece having a fixed size, thus limiting using purpose.

The present invention has arisen to mitigate and/or obviate the afore-described disadvantages.

### SUMMARY OF THE INVENTION

The primary aspect of the present invention is to provide a connection tool which is configured to drive two workpieces of different diameters by using the first large-diameter hexagonal hole and the second large-diameter hexagonal hole, and the first small-diameter hexagonal hole and the second small-diameter hexagonal hole are connected with two drive tools which have a same diameter, thus obtaining multi-purpose use.

To achieve above-mentioned aspect, a connection tool provided by the present invention contains: a first fixing portion and a second fixing portion.

The first fixing portion includes a first large-diameter hexagonal hole, a first small-diameter hexagonal hole extending inward from the first large-diameter hexagonal hole, and a first engagement orifice defined on an outer wall of the first fixing portion proximate to the first large-diameter hexagonal hole and communicating with the first small-diameter hexagonal hole.

The second fixing portion includes a second large-diameter hexagonal hole, a second small-diameter hexagonal hole extending inward from the second large-diameter hexagonal hole, and a second engagement orifice defined on an outer wall of the second fixing portion proximate to the second large-diameter hexagonal hole and communicating with the second small-diameter hexagonal hole, wherein a diameter of the first large-diameter hexagonal hole is less than a diameter of the second large-diameter hexagonal hole.

### BRIEF DESCRIPTION OF THE DRAWINGS

FIG. 1 is a perspective view showing the assembly of a connection tool according to a preferred embodiment of the present invention.

FIG. 2 is another perspective view showing the assembly of the connection tool according to the preferred embodiment of the present invention.

FIG. 3 is a cross sectional view showing the assembly of the connection tool according to the preferred embodiment of the present invention.

FIG. 4 is a perspective view showing the operation of the connection tool according to the preferred embodiment of the present invention.

FIG. 5 is a cross sectional view showing the operation of the connection tool according to the preferred embodiment of the present invention.

### DETAILED DESCRIPTION OF THE PREFERRED EMBODIMENTS

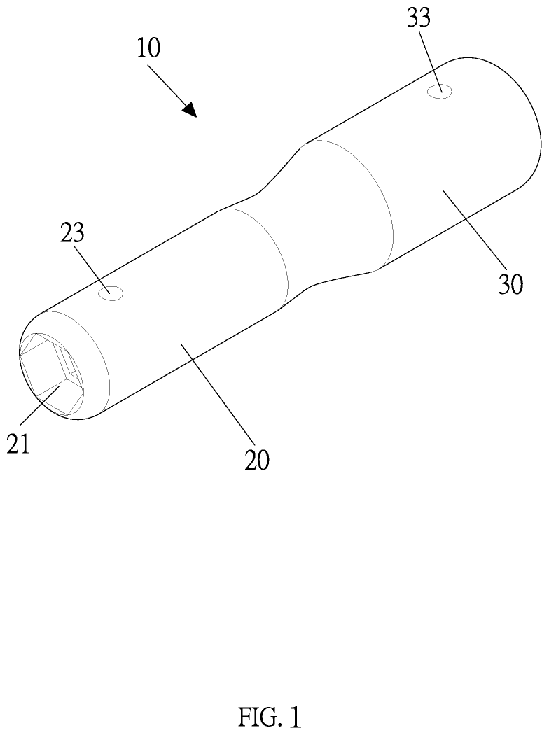

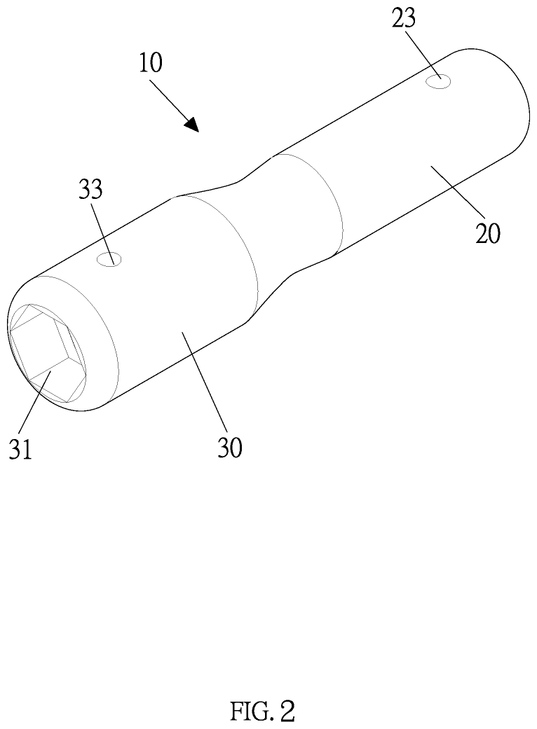

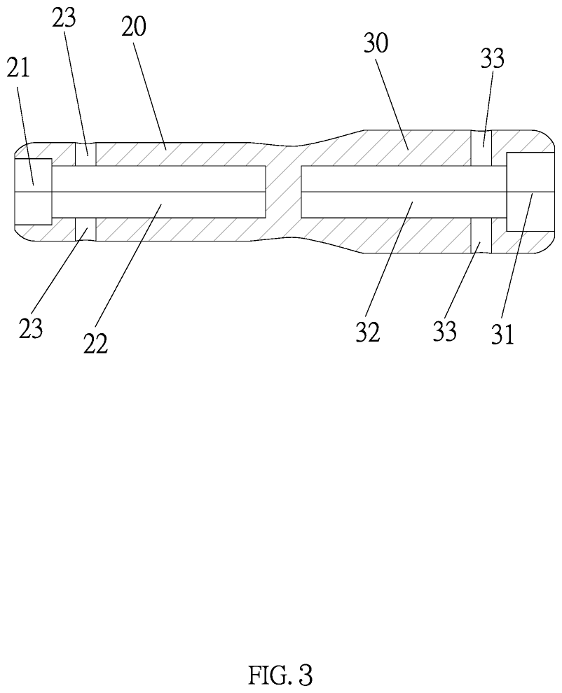

With reference to FIGS. 1-3, a connection tool 10 according to a preferred embodiment of the present invention comprises: a first fixing portion 20 formed on a first end of the connection tool 10, a second fixing portion 30 formed on a second end of the connection tool 10.

The first fixing portion 20 includes a first large-diameter hexagonal hole 21, a first small-diameter hexagonal hole 22 extending inward from the first large-diameter hexagonal hole 21, and a first engagement orifice 23 defined on an outer wall of the first fixing portion 20 proximate to the first large-diameter hexagonal hole 21 and communicating with the first small-diameter hexagonal hole 22.

The second fixing portion 30 includes a second large-diameter hexagonal hole 31, a second small-diameter hexagonal hole 32 extending inward from the second large-diameter hexagonal hole 31, and a second engagement orifice 33 defined on an outer wall of the second fixing portion 30 proximate to the second large-diameter hexagonal hole 31 and communicating with the second small-diameter hexagonal hole 32, wherein a diameter of the first large-diameter hexagonal hole 21 is less than a diameter of the second large-diameter hexagonal hole 31, and the first small-diameter engagement orifice 23 does not communicate with the second small-diameter engagement orifice 33.

Thereby, the connection tool 10 is configured to drive two workpieces of different diameters by using the first large-diameter hexagonal hole 21 and the second large-diameter hexagonal hole 31, and the first small-diameter hexagonal hole 22 and the second small-diameter hexagonal hole 32 are connected with two drive tools which have a same diameter, thus obtaining multi-purpose use of the connection tool 10.

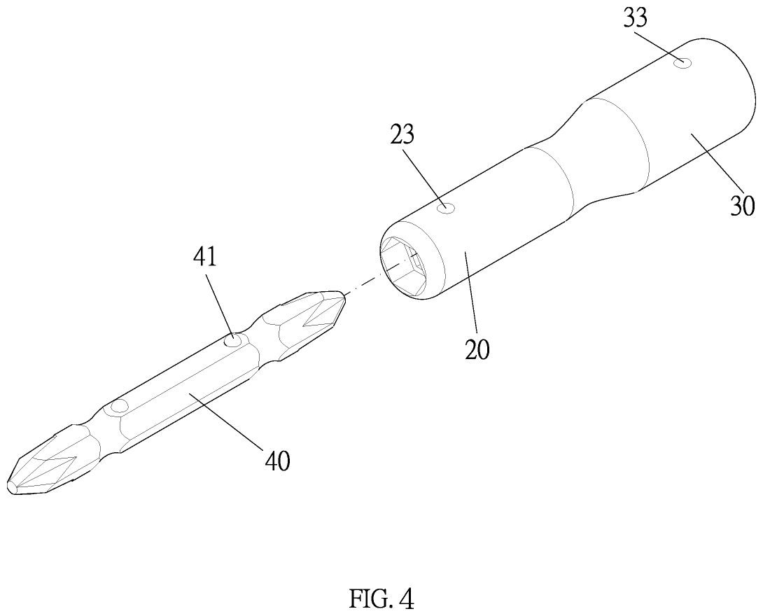

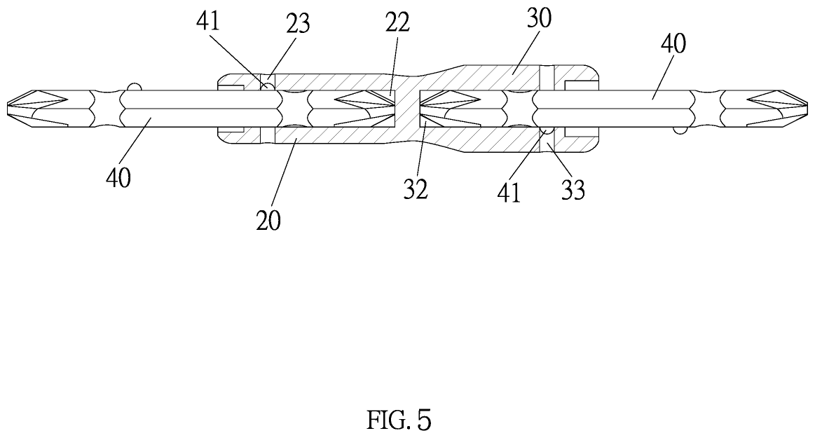

Referring to FIGS. 4-5, a respective drive tool 40 includes a ball 41 engaged on a middle section thereof, and the middle section of the respective drive tool 40 is formed in a hexagon shape, such that when the respective drive tool 40 is received in the first small-diameter hexagonal hole 22 or the second small-diameter hexagonal hole 32, the ball 41 of the respective drive tool 40 is engaged in the first small-diameter hexagonal hole 22 or the second small-diameter hexagonal hole 32, thus connecting the respective drive tool 40 with the connection tool 10.

While the preferred embodiments of the invention have been set forth for the purpose of disclosure, modifications of the disclosed embodiments of the invention and other embodiments thereof may occur to those skilled in the art. Accordingly, the appended claims are intended to cover all embodiments which do not depart from the spirit and scope of the invention.

What is claimed is:

1. A connection tool comprising:
a first fixing portion formed on a first end of the connection tool, a second fixing portion formed on a second end of the connection tool;
wherein the first fixing portion includes a first large-diameter hexagonal hole, a first small-diameter hexagonal hole extending inward from the first large-diameter hexagonal hole, and a first engagement orifice defined on an outer wall of the first fixing portion proximate to the first large-diameter hexagonal hole and communicating with the first small-diameter hexagonal hole;
wherein the second fixing portion includes a second large-diameter hexagonal hole, a second small-diameter hexagonal hole extending inward from the second large-diameter hexagonal hole, and a second engagement orifice defined on an outer wall of the second fixing portion proximate to the second large-diameter hexagonal hole and communicating with the second small-diameter hexagonal hole, wherein a diameter of the first large-diameter hexagonal hole is less than a diameter of the second large-diameter hexagonal hole.

2. The connection tool as claimed in claim 1, wherein the first small-diameter engagement orifice does not communicate with the second small-diameter engagement orifice.

3. The connection tool as claimed in claim 1, wherein the connection tool is configured to drive two workpieces of different diameters by using the first large-diameter hexagonal hole and the second large-diameter hexagonal hole, and the first small-diameter hexagonal hole and the second small-diameter hexagonal hole are connected with two drive tools which have a same diameter;
wherein a respective drive tool includes a ball engaged on a middle section thereof, and the middle section of the respective drive tool is formed in a hexagon shape, such that when the respective drive tool is received in the first small-diameter hexagonal hole or the second small-diameter hexagonal hole, the ball of the respective drive tool is engaged in the first small-diameter hexagonal hole or the second small-diameter hexagonal hole, thus connecting the respective drive tool with the connection tool.
